(19) United States
(12) Patent Application Publication
(10) Pub. No.: US 2008/0132415 A1
(43) Pub. Date: Jun. 5, 2008

(54) Method For Increasing Maize Yields

(76) Inventors: Jayla R. Allen, Apex, NC (US); Mark D. Parrish, Raleigh, NC (US)

Correspondence Address: BAYER CROPSCIENCE LP, Patent Department, 2 T .W. ALEXANDER DRIVE, RESEARCH TRIANGLE PARK, NC, 27709, US

(21) Appl. No.: 11/792,445

(22) PCT Filed: Dec. 12, 2005
(86) PCT No.: PCT/US05/45074

§ 371 Date: Jun. 6, 2007

Related U.S. Application Data
(60) Provisional application No. 60/635,877, filed on Dec. 14, 2004.

(51) Int. Cl. A01N 43/56; A01P 21/00

(52) U.S. Cl. 504/282

(57) ABSTRACT

The present invention provides methods of improving yields in crops of useful plants in need of yield improvement, such as maize, by applying a yield-improving amount of isoxadifen or an ester thereof to the plants, parts of plants, plant seeds or the area under cultivation. Also provided are methods of improving yields in crops of useful plants in need of yield improvement by applying a herbicidally effective amount of one or more herbicides and/or insecticides and yield-improving amount of isoxadifen or an ester thereof to the plants, parts of plants, plant seeds or the area under cultivation. Suitable herbicides can include, for example, rimsulfuron, nicosulfuron, foramsulfuron, diflufenzopyr, mesotrione or dicamba. One exemplary combination of a yield-improving application of isoxadifen with more herbicide is a yield-improving application of isoxadifen combined with diflufenzopyr and dicamba.

### BACKGROUND OF THE INVENTION

1. Field of the Invention

The invention relates to the technical field of crop protection products, in particular safeners and safeners in combination with herbicides which are suitable for use against competing harmful plants in crops of useful plants.

2. Description of Related Art

It is known that many herbicides injure crop plants at herbicide application rates needed to control weed growth. This renders many herbicides unsuitable for controlling weeds in the presence of certain crops. This effect is encountered in particular with the use of a considerable number of herbicides in crops such as maize, rice, or cereals, and there primarily in the post-emergence application of the herbicides. However, where weed growth is uncontrolled, this results in lower crop yield and reduced crop quality, as weeds will compete with crops for nutrients, light and water. Reduction in herbicidal injury to crops without an unacceptable reduction in the herbicidal action can be accomplished by use of crop protectants known as “safeners,” also sometimes referred to as “antidotes” or “antagonists.” Useful plants, therefore, can be protected in some instances against the phytotoxic properties of pesticides by employing safeners, or antidotes, without adversely affecting the pesticidal activity against the harmful organisms.

Herbicidally active compounds from the auxin type of aromatic carboxylic acids have good use properties and can be employed at relatively low application rates against a range of gramineous and/or broad-leaved weeds; see, for example, U.S. Pat. No. 3,013,054; U.S. Pat. No. 3,014,063; U.S. Pat. No. 3,174,842; U.S. Pat. No. 3,081,162 and U.S. Pat. No. 2,848,470. However, these compounds are not always fully compatible with some important crop plants, such as the cereals wheat, barley, rice, maize and sorghum, or dicotyledonous crops, such as soya bean, sunflower and sugar cane, (including transgenic selective herbicide tolerant varieties such as glufosinate tolerant varieties, for example LIBERTY LINK® corn, or glyphosate tolerant varieties, for example ROUND-UP-READY® corn or soybean) so that their use as selective herbicides is in some instances limited. The herbicides can in this case only be used, if at all, at application rates which are compatible with the crops and so low that the desired broad herbicidal action against harmful plants is not ensured.

It is already known from EP-A-0480902 that the addition of some safeners of the dichloroacetamide type and various other safeners can reduce phytotoxicity of benzoic acid type herbicides on crops.

EP-A-0795269 describes the combination of cloquintocet-mexyl or similar safeners of the quinolinoxyacetate type for reducing phytotoxicity of dicamba on crops.

WO 98/47356 relates to combinations of dicamba and specific dichloroacetamide safeners having heterocyclic rings, such as furilazole, benoxacor, AD 97 or specific dicarboxylic acid safeners having heterocyclic rings.

Compounds which have hitherto been disclosed as safeners have various chemical structures. For example, U.S. Pat. No. 4,902,340 discloses derivatives of quinolin-8-oxy-alkanoic acids as safeners for herbicides from the group of the diphenyl ethers and the pyridyloxyphenoxypropionic acids; and EP-A 0 520 371 discloses isoxazolines and isothiazolines as safeners for various kinds of herbicides, such as aryloxyphenoxycarboxylic acids, sulfonylureas and imidazolinones, which are mentioned as preferred herbicides in the latter publication.

However, when using safeners for protecting useful plants against damage by pesticides, it has been found that in many instances known safeners have certain disadvantages. These disadvantages include the safener reducing the activity of the pesticides, in particular, those of herbicides, against harmful plants; the crop-protecting properties are insufficient in combination with a given herbicide; the spectrum of the useful plants in which the safener/herbicide is to be employed is not sufficiently wide; or a given safener cannot be combined with a sufficiently large number of herbicides.

There exists a need, therefore, to provide crop protection agents comprising compounds having improved safener action which can reduce the damage caused by the application of pesticides to useful plants so as to increase crop yield and which can be used on a wide variety of useful plants.

### SUMMARY OF THE INVENTION

The present invention fulfills this need by providing a crop protection safener comprising isoxadifen or esters thereof that surprisingly can substantially improve crop yields of useful plants, such as maize.

In particular, the present invention provides methods of improving yields in crops of useful plants in need of yield improvement, such as maize, by applying a yield-improving amount of isoxadifen or an ester thereof to the plants, parts of plants, plant seeds or the area under cultivation. In a particular embodiment, a yield-improving amount of isoxadifen, an ester of isoxadifen and combinations thereof are applied according to the methods of the present invention.

The present invention also provides methods of improving yields in crops of useful plants in need of yield improvement by applying a yield-improving amount of isoxadifen or an ester thereof and an effective amount of one or more herbicides and/or insecticides to the plants, parts of plants, plant seeds or the area under cultivation.

Suitable herbicides used in the methods of the present invention include, for example and without limitation, rimsulfuron, nicosulfuron, foramsulfuron, diflufenzopyr, mesotrione or dicamba. One exemplary combination of a yield-improving application of isoxadifen with more than one herbicides is a yield-improving application of isoxadifen combined with diflufenzopyr and dicamba.

The application rate of isoxadifen or an ester thereof can vary within wide limits and is generally in the range from 0.001 to 5 kg, preferably from 0.005 to 0.5 kg, more preferably from 0.015 to 0.1 kg of isoxadifen active compound (a.i.) per hectare, or, for seed treatment use, is, for example, from 0.01 g to 10 g a.i. per kg seed, preferably 0.05 g to 1 g a.i. per kg seed, in particular 0.1 g to 0.5 g a.i. per kg seed.

The application rate of the herbicides and/or insecticides used according to the methods of the present invention can be varied within wide limits, the optimum amount depending on the herbicide and/or insecticide in question, the spectrum of harmful plants and the crop plants. In general, the application rate is in the range from 0.001 g to 12 kg, preferably 10 g to 3 kg, very particularly 20 g to 2 kg a.i. per ha.

The herbicidally active compounds and/or insecticides and isoxadifen or an ester thereof can be applied together (as finished formulation or by the tank-mix method) or sequentially in any order. The weight ratio of herbicide:isoxadifen can vary within wide limits and is, for example, in the range from 1:200 to 200:1, preferably from 1:100 to 100:1, in particular, from 1:20 to 20:1, most preferably from 1:10 to 10:1. Isoxadifen or esters thereof may be used for pre-treating the seed of the crop plant (seed dressing) or the seedlings to be incorporated into the seed furrow prior to sowing. In the pretreatment of seedlings it is possible, for example, to spray the roots or the entire seedling with a solution of isoxadifen or to dip them into such a solution. The use of one or more herbicides can then be carried out by a pre-emergence or post-emergence method.

Alternatively, it is possible to apply isoxadifen together with the herbicides before or after emergence of the plants. Pre-emergence treatment includes both the treatment of the area under cultivation prior to sowing and the treatment of the areas under cultivation where the crops have been sown but not yet emerged. A sequential procedure, where the treatment with isoxadifen is carried out first, followed, preferably closely, by application of the herbicide, also is possible. In individual cases, it also may be expedient to apply isoxadifen after application of the herbicide.

In general, simultaneous application of isoxadifen and at least one herbicide in the form of tank mixes or finish formulations is preferred.

If solutions of isoxadifen are used in the seed treatment method wherein the seeds are soaked in the isoxadifen solution, the concentration of the safener in the solution is for example from 1 to 10,000 ppm, preferably 100 to 1,000 ppm based on weight.

Isoxadifen and the herbicides used in combination with isoxadifen according to the methods of the present invention are understood to embrace all stereoisomers and mixtures thereof, as well as their salts.

### BRIEF DESCRIPTION OF THE DRAWINGS

FIG. 1 is a bar graph showing the percentage of corn injury seven days post application of various herbicides with and without isoxadifen;

FIG. 2 is a bar graph showing corn yield as a percentage of control seven days post application of various herbicides with and without isoxadifen;

FIG. 3 is a bar graph showing the percentage of corn injury and corn yield as a percentage of control seven days post application of a combination of dicamba and diflufenzopyr and an organophosphate insecticide, chlorpyrifos, with and without isoxadifen;

FIG. 4 is a bar graph showing the percentage of corn injury and corn yield as a percentage of control seven days post application of a combination of dicamba and chlorpyrifos, with and without isoxadifen;

FIG. 5 is a bar graph showing the percentage of corn injury and corn yield as a percentage of control seven days post application of a combination of rimsulfuron and chlorpyrifos, with and without isoxadifen;

FIG. 6 is a bar graph showing the percentage of corn injury and corn yield as a percentage of control seven days post application of a combination of nicosulfuron, rimsulfuron and chlorpyrifos, with and without isoxadifen;

FIG. 7 is a bar graph showing the percentage of corn injury and corn yield as a percentage of control seven days post application of a combination of mesotrion and chlorpyrifos, with and without isoxadifen; and

FIG. 8 is a bar graph showing the percentage corn injury and corn yield as a percentage of control seven days post application of a combination of foramsulfuron and chlorpyrifos, with and without isoxadifen.

### DESCRIPTION OF THE PREFERRED EMBODIMENTS

We have now shown that, surprisingly, yields of crop plants can be substantially improved by applying a yield-improving amount of the safener isoxadifen or an ester thereof to the plants, parts of plants, plant seeds or the area under cultivation.

Accordingly, the present invention provides methods of improving yields in crops of useful plants in need of yield improvement, such as maize, by applying a yield-improving amount of isoxadifen or an ester thereof to the plants, parts of plants, plant seeds or the area under cultivation. In a particular embodiment, a yield improving amount of isoxadifen, an ester of isoxadifen and combinations thereof are applied according to the methods of the present invention.

We now also have shown that yields of crops of useful plants can be substantially improved if isoxadifen or an ester thereof is applied together with other pesticidally active substances, such as, for example, insecticides, acaricides, nematicides, herbicides, fungicides, fertilizers and/or growth regulators, for example in the form of a finished formulation or in tank mixes.

The preferred additional one or more active compounds is a herbicide.

The present invention, therefore, also provides methods of improving yields in crops of useful plants in need of yield improvement by applying a herbicidally effective amount of one or more herbicides and a yield-improving amount of isoxadifen or an ester thereof to the plants, parts of plants, plant seeds or the area under cultivation.

Suitable herbicides used in the methods of the present invention include, without limitation, rimsulfuron, nicosulfuron, foramsulfuron, diflufenzopyr, mesotrione or dicamba.

In individual cases, it may be advantageous to combine one of isoxadifen or an ester thereof with a plurality of herbicides. One exemplary combination of a yield-improving application of isoxadifen with more than one herbicide is a yield-improving application of isoxadifen combined with diflufenzopyr and dicamba.

The application rate of isoxadifen or an ester thereof can vary within wide limits and is generally in the range from 0.001 to 5 kg, preferably from 0.005 to 0.5 kg, more preferably from 0.015 to 0.1 kg of isoxadifen active compound (a.i.) per hectare, or for seed treatment use is, for example, from 0.01 g to 10 g a.i. safener per kg seed, preferably 0.05 g to 1 g a.i. safener per kg seed, in particular 0.1 g to 0.5 g a.i. safener per kg seed.

The application rate of the herbicides used according to the methods of the present invention can be varied within wide limits, the optimum amount depending on the herbicide in question, the spectrum of harmful plants and the crop plants. In general, the application rate is in the range from 0.001 g to 12 kg, preferably 10 g to 3 kg, very particularly 20 g to 2 kg a.i. per hectare.

The herbicidally active compounds and isoxadifen or an ester thereof can be applied together (as finished formulation or by a tank-mix method) or sequentially in any order. The weight ratio of herbicide:isoxadifen can vary within wide limits and is, for example, in the range from 1:200 to 200:1, preferably from 1:100 to 100:1, in particular from 1:20 to 20:1, most preferably from 1:10 to 10:1. Isoxadifen or esters thereof may be used for pre-treating the seed of the crop plant (seed dressing) or the seedlings or be incorporated into the seed furrow prior to sowing. In the pretreatment of seedlings it is possible, for example, to spray the roots or the entire seedling with a solution of isoxadifen or to dip them into such a solution. The use of one or more herbicides can then be carried out by a pre-emergence or post-emergence method.

Alternatively, it is possible to apply isoxadifen together with the herbicides, before or after emergence of the plants. Pre-emergence treatment includes both the treatment of the area under cultivation prior to sowing and the treatment of the areas under cultivation where the crops have been sown but not yet emerged. A sequential procedure, where the treatment with the safener is carried out first, followed, preferably closely, by application of the herbicide, is also possible. In individual cases, it may also be expedient to apply the safener after application of the herbicide.

In general, simultaneous application of the safener and at least one herbicide in the form of tank mixes or finish formulations is preferred.

If solutions of safeners are used in the seed treatment method wherein the seeds are soaked in the safener solution, the concentration of the safener in the solution is, for example, from 1 to 10,000 ppm, preferably 100 to 1000 ppm, based on weight.

The safener isoxadifen and the herbicides used in combination with isoxadifen are understood to embrace all stereoisomers and mixtures thereof, as well as their salts.

The advantageous yield-improving effects of isoxadifen and herbicidal application are observed when isoxadifen and at least one herbicide are applied simultaneously. However, yield-improving effects also can be observed when isoxadifen and at least one herbicide are applied at different times (splitting). It also is possible to apply the active compounds in a plurality of portions (sequential application), for example, after pre-emergence applications, followed by post-emergence applications, or after early post-emergence applications, followed by medium or late post-emergence applications. It also is possible to use isoxadifen as a dressing for pretreating the seeds of the crop plants or plant seedlings.

The isoxadifen-herbicide combinations of the present invention reduce or eliminate phytotoxic effects which can occur when the herbicides are used in useful plants, without having any substantial detrimental effect on the activity of these active compounds against harmful plants. Additionally, the isoxadifen-herbicide combinations permit a higher dosage (application rate) of the herbicide compared to the individual application of the herbicide in crops of useful plants, and thus, a more effective control of the competing harmful plants. The higher efficacy permits the control of species which are as yet uncontrolled (gaps), an extension of the period of application and/or a reduction in the number of individual applications required and, as a result for the user, weed control systems which are more advantageous economically and ecologically.

The safener isoxadifen and suitable herbicides used according to the methods of the present invention are known. The preparation of such compounds is described, for example, in the above mentioned publications, or can be carried out, for example, by or analogously to the methods described in these publications.

For the preferred compounds, their preparation and general conditions for their use and, in particular, for specific example compounds, reference is made to the descriptions of the publications mentioned, and these descriptions are also part of the present invention.

Isoxadifen alone or when combined with at least one herbicide according to the methods of the present invention is suitable for improving crop yield in a number of crop plants, for example in economically important crops such as cereals wheat, barley, rice, maize and sorghum, or dicotyledonous crops, such as soya bean, sunflower and sugar cane, (including ®Liberty link corn and ®Round-up Ready corn or soybean). Of particular interest is the use of isoxadifen in maize.

Isoxadifen or esters thereof can be combined with suitable herbicides according to the methods of the present invention in mixed formulations or in a tank mix as described, for example, in Weed Research 26, 441-445 (1986), or “The Pesticide Manual,” 12th edition, The British Crop Protection Council and the Royal Soc. of Chemistry, 1997 and the literature cited therein.

The isoxadifen-herbicide combinations according to the methods of the present invention have excellent herbicidal activity against a broad spectrum of economically important mono- and dicotyledonous harmful plants. The combinations also act efficiently on perennial weeds which produce shoots from rhizomes, root stocks or other perennial organs and which are difficult to control.

When the isoxadifen-herbicide combinations according to the present invention are applied to the soil surface prior to germination, weed seedlings can be either prevented completely from emerging, or the weeds grow until they have reached the cotyledon stage but then their growth stops, and, eventually, after three to four weeks have elapsed, they can die completely.

If the isoxadifen-herbicide combinations are applied post-emergence to the green parts of the plants, weed growth can also stop drastically a very short time after the treatment and the weed plants remain at the developmental stage of the point in time of application, or they can die completely after a certain time, so that in this manner, competition by the weeds, which is harmful to the crop plants, is eliminated at a very early point in time and in a sustained manner.

Owing to the improved crop yield and decreased crop injury of isoxadifen or the isoxadifen-herbicide combinations, the methods of the present invention encompass controlling harmful plants in known crops or in still to be developed genetically engineered plants. Transgenic plants generally have particularly advantageous properties, for example, resistance to certain pesticides, above all certain herbicides, resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, transgenic plants having an increased starch content or a modified quality of the starch or those having a different fatty acid composition of the harvested product are known.

Isoxadifen or the isoxadifen-herbicide combination according to the methods of the present invention are preferably employed in economically important transgenic crops of useful and ornamental plants, for example, cereals such as wheat, barley, rye, oats, millett, rice, manioc and maize or else in crops of sugar-beet, cotton, soya bean, oil seed rape, potatoes, tomatoes, peas and other vegetable species. Preferably, soxadifen or the isoxadifen-herbicide combinations are employed in transgenic crops of maize.

The isoxadifen-herbicide combinations according to the methods of the present invention can be present both as mixed formulations; if appropriate with other active compounds, additives and/or customary formulation auxiliaries, which are then applied in a customary manner diluted with water; or prepared as so-called tank mixes by joint dilution of the separately formulated or partially separately formulated components with water.

Isoxadifen or esters thereof, or isoxadifen in combination with one or more herbicides can be formulated in various ways depending on the prevailing biological and/or chemico-physical parameters. Examples of suitable formulation options are: wettable powders (WP), emulsifiable concentrates (EC), aqueous solutions (SL), emulsions (EW), such as oil-in-water and water-in-oil emulsions, sprayable solutions or emulsions, oil- or water-based dispersions, suspoemulsions, dusts (DP), seed-dressing compositions, granules for broadcasting and soil application, or water-dispersible granules (WG), ULV formulations, micro-capsules or waxes.

The individual formulation types are known in principle and are described, for example, in Winnacker-Küchler, “Chemische Technologie” [Chemical Technology], Volume 7, C. Hauser Verlag Munich, 4th. Edition 41986; van Valkenburg, “Pesticides Formulations,” Marcel Dekker, N.Y., 1973; K. Martens, “Spray Drying Handbook,” 3rd Ed. 1979, G. Goodwin Ltd. London. The necessary formulation auxiliaries, such as inert materials, surfactants, solvents and other additives, are likewise known and are described, for example, in Watkins, “Handbook of Insecticide Dust Diluents and Carriers,” 2nd Ed., Darland Books, Caldwell N.J., H. v. Olphen, “Introduction to Clay Colloid Chemistry,” 2nd Ed., S. Wiley & Sons, N.Y.; C. Marsden, “Solvents Guide,” 2nd Ed., Interscience, N.Y. 1950; McCutcheon's “Detergents and Emulsifiers Annual,” MC Publ. Corp., Ridgewood N.J.; Sisley and Wood, “Encyclopedia of Surface Active Agents,” Chem. Publ. Co. Inc., N.Y. 1964; Schönfeldt, “Grenzflächenaktive Äthylenoxidaddukte” [Surface-active ethylene oxide adducts], Wiss. Verlagsgesellschoft, Stuttgart 1976; Winnacker-Küchler, “Chemische Technologie” [Chemical Technology], Volume 7, C. Hauser Verlag Munich, 4th Edition 1986.

Based on these formulations it is also possible to produce combinations with other pesticidally active substances, such as other herbicides, fungicides or insecticides, and also with fertilizers and/or growth regulators, for example, in the form of a ready-mix or tank mix.

Wettable powders are preparations which are uniformly dispersible in water and which, in addition to the active compound, contain a diluent or inert substance and surfactants of ionic or nonionic type (wetting agents, dispersants), such as, for example, polyethoxylated alkyl phenols, polyethoxylated fatty alcohols, polyethoxylated fatty amines, alkanesulfonates, alkylbenzenesulfonates, sodium ligninsulfonate, sodium 2,2′-dinaphthylmethane-6,6′-disulfonate, sodium dibutylnaphthalene-sulfonate or sodium oleoylmethyltaurinate.

Emulsifiable concentrates are prepared by dissolving the compound(s) of the present invention in an organic solvent, for example, butanol, cyclohexanone, dimethylformamide, xylene or else relatively high-boiling aromatic compounds or hydrocarbons with the addition of one or more surfactants of ionic or nonionic type (emulsifiers). Examples of emulsifiers which can be used are calcium alkylarylsulfonates, such as Ca dodecylbenzenesulfonate, or nonionic emulsifiers, such as fatty acid polyglycol esters, alkylaryl polyglycol ethers, fatty alcohol polyglycol ethers, propylene oxide-ethylene oxide condensation products, alkyl polyethers, sorbitan fatty acid esters, polyoxyethylene sorbitan fatty acid esters or polyoxyethylene sorbitan esters.

Dusts are obtained by grinding the compounds of the present invention with finely divided solid substances, for example, talc, natural clays, such as kaolin, bentonite and pyrophyllite, or diatomaceous earth.

Granules can be prepared either by spraying the compounds of the present invention onto adsorptive, granulated inert material or by applying the compounds' concentrates to the surface of carriers such as sand, kaolinites or granulated inert material, by means of adhesive binders, for example, polyvinyl alcohol, sodium polyacrylate or mineral oils. The compounds of the present invention also can be granulated in the manner which is customary for the preparation of fertilizer granules, if desired, as a mixture with fertilizers. Water-dispersible granules are generally prepared by processes such as spray-drying, fluidized-bed granulation, disk granulation, mixing using high-speed mixers, and extrusion without solid inert material.

The agrochemical formulations generally contain from 0.1 to 99% by weight, in particular from 2 to 95% by weight, of isoxadifen or isoxadifen in combination with one or more herbicides, the following concentrations being customary, depending on the type of formulations: In wettable powders the concentration of the compounds are, for example, from about 10 to 95% by weight, the remainder, to 100% by weight consisting of customary formulation constituents. In emulsifiable concentrates the concentration of the compounds can be, for example, from 5 to 80% by weight.

Formulations in the form of dusts usually contain from 5 to 20% by weight of the compound(s) of the present invention; while sprayable solutions contain from about 0.2 to 25% by weight of the compounds.

In the case of granules, such as dispersible granules, the content of the compounds depends partly on whether the compounds are in liquid or solid form and on what granulation auxiliaries and fillers are used. In water-dispersible granules the content is generally between 10 and 90% by weight.

In addition, said formulations of the compounds of the present invention may comprise tackifiers, wetting agents, dispersants, emulsifiers, preservatives, antifreeze agents and solvents, fillers, colorants and carriers, antifoams, evaporation inhibitors, pH and viscosity regulators, thickeners and/or fertilizers which are customary in each case.

For use, the formulations, which are in commercially available form, are, if appropriate, diluted in a customary manner, for example, using water in the case of wettable powders, emulsifiable concentrates, dispersions and water-dispersible granules. Preparations in the form of dusts, soil granules, granules for spreading and sprayable solutions are conventionally not diluted any further with other inert substances prior to use.

Isoxadifen or isoxadifen in combination with one or more herbicides can be applied to the plants, parts of the plants, seeds of the plants or the area under cultivation (tilled soil), preferably to the green plants and parts of the plants and, if desired, additionally, to the tilled soil.

A possible use is the joint application of the isoxadifen and one or more herbicides in the form of tank mixes, where the concentrated formulations of the individual compounds, in the form of their optimal formulations, are mixed jointly with water in the tank, and the resulting spray mixture is applied.

The present invention is more particularly described in the following non-limiting examples, which are intended to be illustrative only, as numerous modifications and variations therein will be apparent to those skilled in the art.

### EXAMPLES

### Example 1

### Effect of Isoxadifen on Corn Tolerance Combined with Postemergence Corn Herbicides

A field study was conducted to examine the effect of isoxadifen on corn injury and corn yield when applied in combination with post-emergence corn herbicides.

### Material and Methods

The study was conducted in Bloomington, DeKalb and Urbana, Ill. to evaluate the crop response when isoxadifen was used with postemergence corn herbicides. Two hybrid corn species with different levels of tolerance were used in the study: Pioneer 33K81, a species sensitive to plant growth regulators (PGRs), isoxazole, amides and sulfonylureas (SUs); and Pioneer 33P66, a tolerant species. Plots were kept weed-free to eliminate any competition from weeds.

The following herbicides and their respective field use rates were used in the study:

rimsufuron—26 g/ha; nicosulfuron+rimsulfuron—39 g/ha; foramsulfuron—37 g/ha; diflufenzopyr+dicamba—294 g/ha; mesotrione—105 g/ha; and dicamba—560 g/ha. One or more of the herbicides were used with or without isoxadifen—37 g/ha. All herbicides were applied at the 1× labeled field use rates.

Timing of the application of the compounds was at the V6 growth stage (i.e., when there were six visible collars of the corn). Additionally, methylated seed oil (MSO)+28% ureas and ammonium sulfate (UAN) were applied at a concentration of 1% v/v+2.5% v/v.

### Results

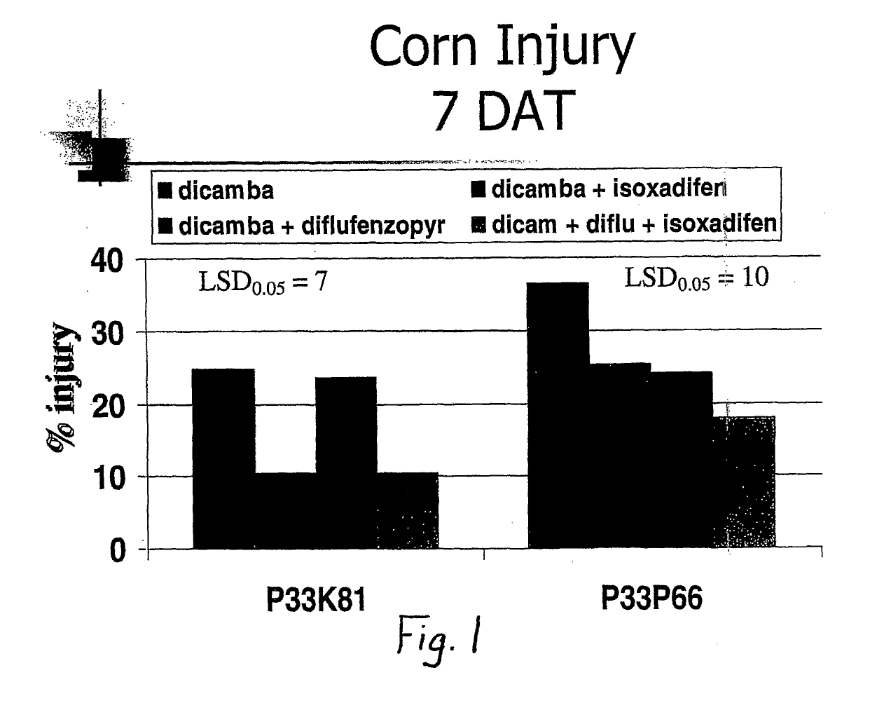

Corn injury 7 days post application of dicamba, dicamba+isoxadifen, dicamba+diflufenzopyr or dicamba+diflufenzopyr+isoxadifen is shown in FIG. 1 and Table 1. In 33K81 corn, application of isoxadifen and dicamba together significantly decreased corn injury compared to application of dicamba alone; and application of isoxadifen with dicamba and diflufenzopyr together significantly decreased corn injury compared to application of dicamba and diflufenzopyr. In 33P66 corn, application of isoxadifen and dicamba together significantly decreased corn injury compared to application of dicamba alone. There was no significant difference between application of isoxadifen with dicamba and diflufenzopyr together compared to application of dicamba and diflufenzopyr.

TABLE 1
PERCENTAGE OF CORN INJURY

| | Pioneer | Pioneer |
|---|---|---|
| Treatment | 33K81 | 33P66 |
| Dicamba | 25% | 36% |
| Dicamba + isoxadifen | 10% * | 25% * |
| Dicamba + Diflufenzopyr | 23% | 24% |
| Dicamba + Diflufenzopyr + | 10% * | 18% |
| Isoxadifen | | |

* p < 0.05

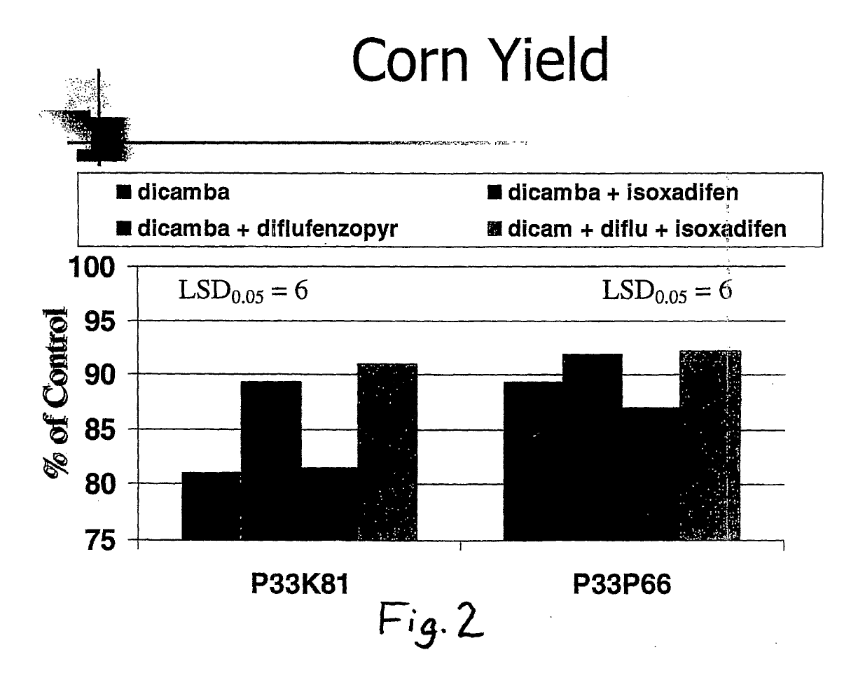

Corn yield as a percentage of control 7 days post application of dicamba, dicamba+isoxadifen, dicamba+diflufenzopyr and dicamba+diflufenzopyr+isoxadifen is shown in FIG. 2 and Table 2. In 33K81 corn, application of isoxadifen and dicamba together significantly increased corn yield compared to application of dicamba alone; and application of isoxadifen with dicamba and diflufenzopyr together significantly increased corn yield compared to application of dicamba and diflufenzopyr. In 33P66 corn, application of isoxadifen and dicamba together significantly increased corn yield compared to application of dicamba alone, and application of isoxadifen with dicamba and diflufenzopyr together significantly increased corn yield compared to application of dicamba and diflufenzopyr.

### Discussion

Among the herbicides tested, dicamba and dicamba plus diflufenzopyr resulted in less crop injury when tank-mixed with isoxadifen, compared with the same herbicide without isoxadifen with both hybrids 7 days after treatment. The addition of isoxadifen resulted in less crop injury when tank-mixed with rimsulfuron with the P33K81 hybrid corn (data not shown). There was no significant difference in adding isoxadifen with mesotrione or nicosulfuron plus rimsulfuron (data not shown).

TABLE 2
CORN YIELD - PERCENTAGE OF CONTROL

| | Pioneer | Pioneer |
|---|---|---|
| Treatment | 33K81 | 33P66 |
| Dicamba | 81% | 89% |
| Dicamba + isoxadifen | 89% * | 92% * |
| Dicamba + Diflufenzopyr | 81% | 87% |
| Dicamba + Diflufenzopyr + | 91% * | 93% * |
| Isoxadifen | | |

* p < 0.05

### Example 2

### Effect of Isoxadifen Tank-Mixed with Chlorpyrifos and Post-Emergence Corn Herbicides

A field study was conducted to examine the effect of isoxadifen on corn injury and corn yield when applied in combination with chlorpyrifos, an organophosphate insecticide, and post-emergence corn herbicides.

### Materials and Methods

The study was conducted in Bloomington, DeKalb and Urbana, Ill. to determine the effects of foramsulfuron tank-mixed with chlorpyrifos, an organophosphate insecticide, with and without the safener, isoxadifen. The hybrid corn species Golden Harvest was used in the study.

The following herbicides and their respective field use rates were used in the study: rimsufuron—26 g/ha; nicosulfuron+rimsulfuron—39 g/ha; foramsulfuron—37 g/ha; diflufenzopyr+dicamba—294 g/ha; mesotrione—105 g/ha; and dicamba—560 g/ha. On one or more of the herbicides were used in combination with the insecticide chlorpyrifos—841 g/ha and with or without isoxadifen—37 g/ha.

Timing of the application of the compounds was at the V6 growth stage and when the corn reached 25 cm in height. A CO₂ backpack sprayer was used to apply the compounds at 187 L/ha at 247 kPa.

### Results

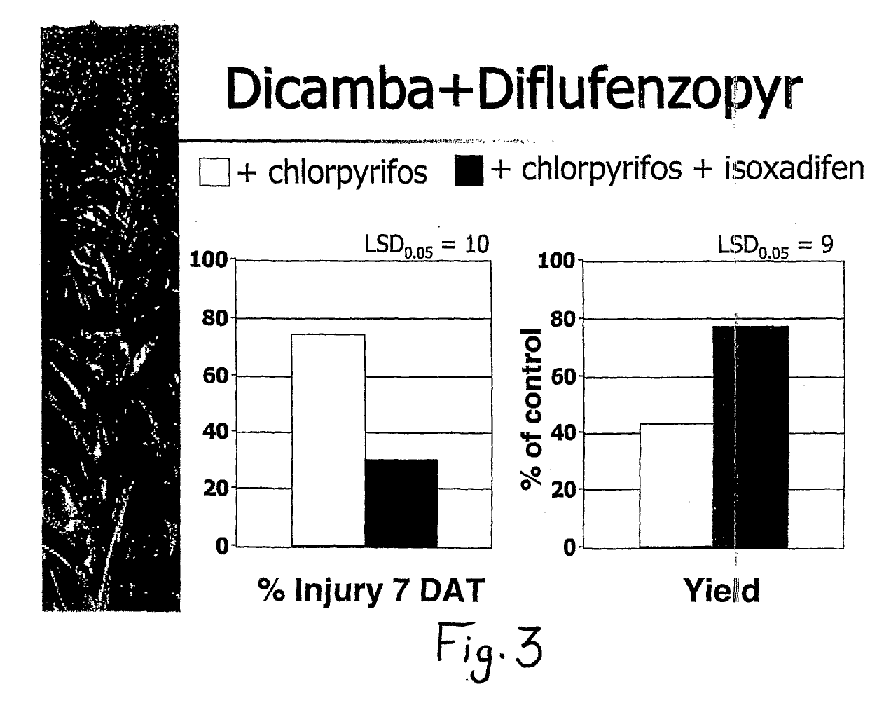

Percentage of corn injury and corn yield are shown in FIGS. 3-8 and Table 3. Application of isoxadifen and dicamba together significantly increased corn yield compared to application of dicamba alone; and application of isoxadifen with dicamba and diflufenzopyr together significantly increased corn yield compared to application of dicamba and diflufenzopyr.

Application of the herbicides dicamba and diflufenzopyr in combination with chlorpyrifos caused significantly more corn injury compared to the application of the above combination and isoxadifen; and application of dicamba and diflufenzopyr in combination with chlorpyrifos produced a significantly smaller corn yield compared to application of the above combination and isoxadifen (FIG. 3).

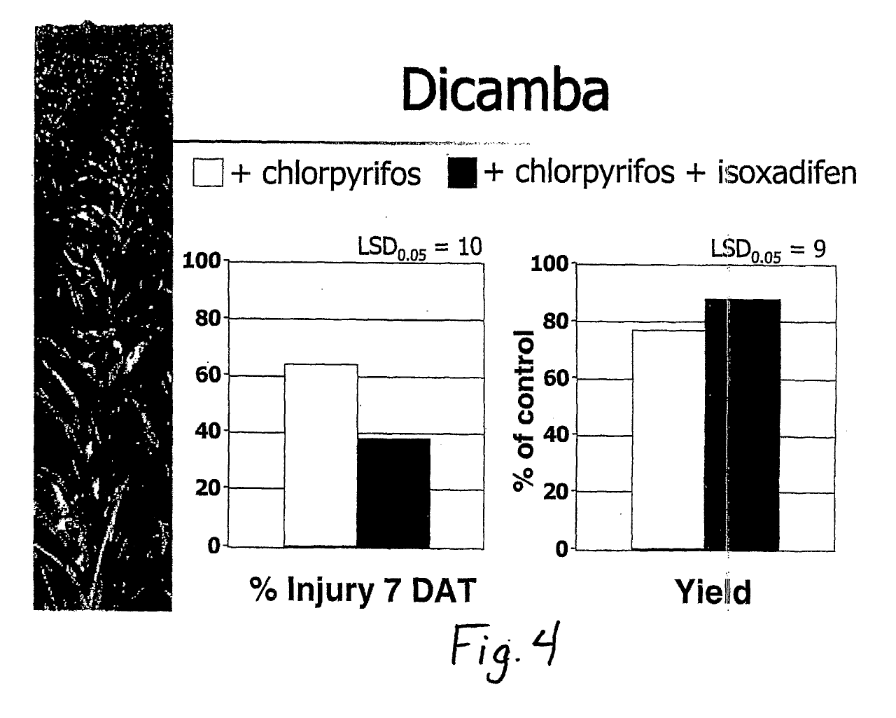

Application of the herbicide dicamba in combination with chlorpyrifos caused significantly more corn injury compared to application of the above combination and isoxadifen; and application of dicamba in combination with chlorpyrifos produced a significantly smaller corn yield compared to the application of the above combination and isoxadifen (FIG. 4).

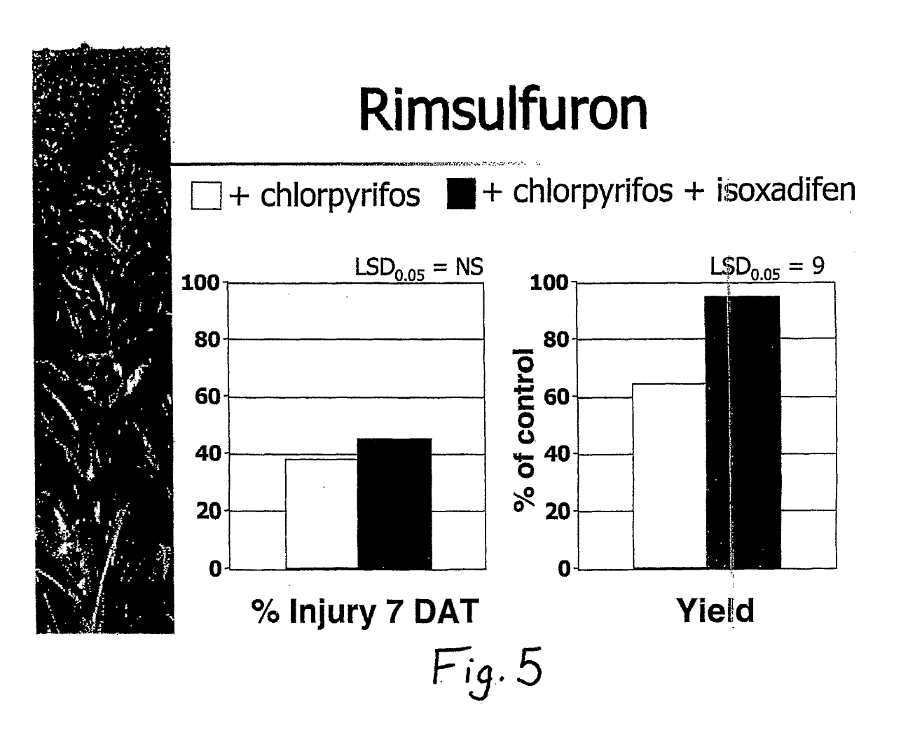

There was no significant difference in the percentage of corn injury when rimsulfuron in combination with chlorpyrifos was applied compared to the application of rimsulfuron in combination with chlorpyrifos and isoxadifen. Application of rimsulfuron in combination with chlorpyrifos produced a significantly smaller corn yield compared to the application of rimsulfuron in combination with chlorpyrifos and isoxadifen (FIG. 5).

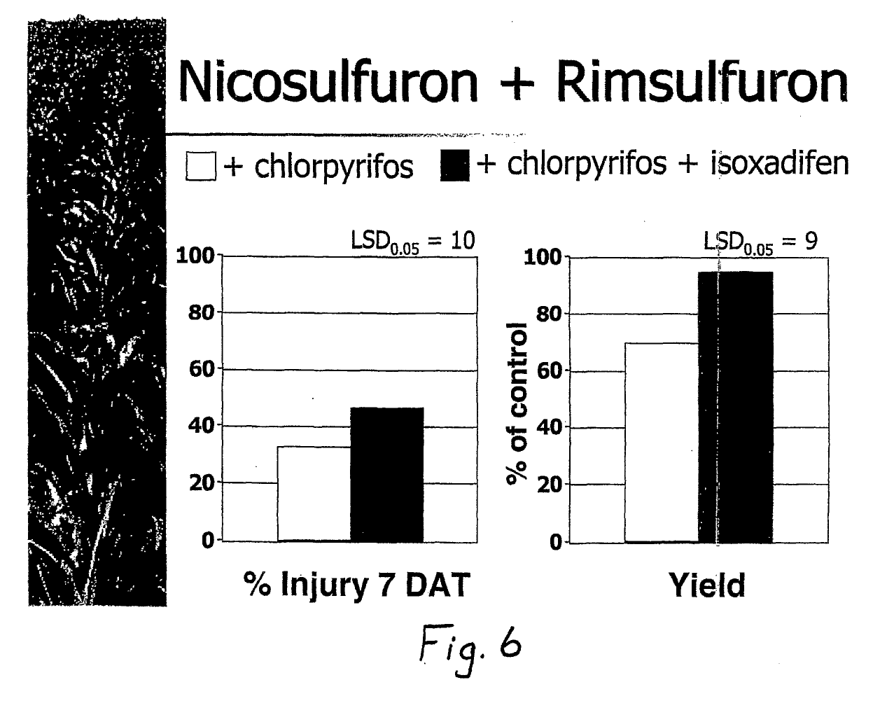

Application of the herbicides nicosulfuron and rimsulfuron in combination with chlorpyrifos and isoxadifen caused significantly more corn injury compared to the application of nicosulfuron and rimsulfuron in combination with chlorpyrifos. Application of nicosulfuron and rimsulfuron in combination with chlorpyrifos produced a significantly smaller corn yield compared to application of the above combination and isoxadifen (FIG. 6).

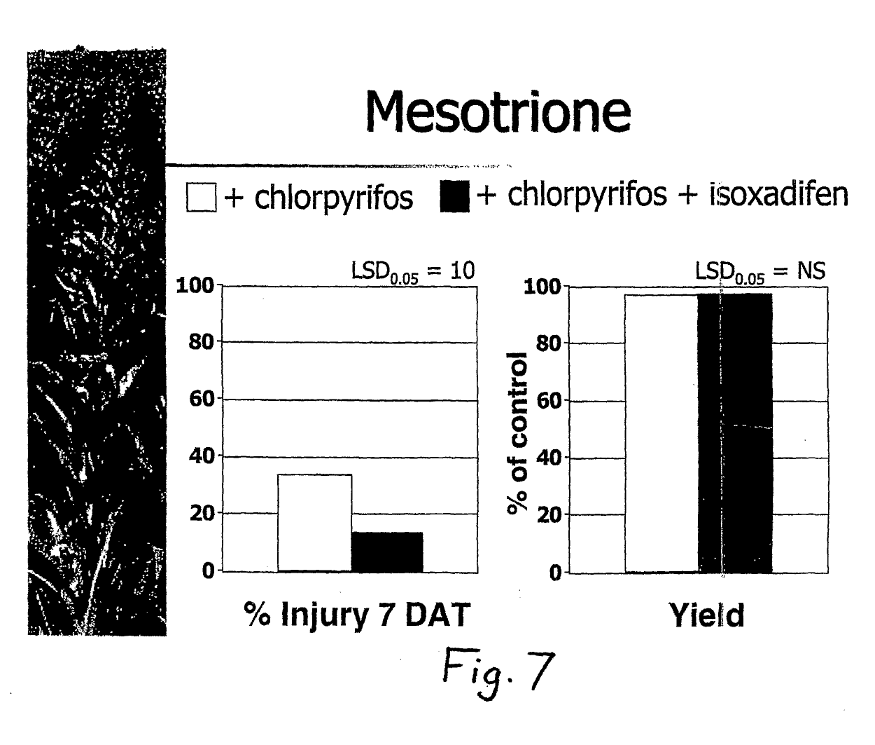

Application of mesotrione in combination with chlorpyrifos caused significantly more corn injury compared to the application of the above combination and isoxadifen. There was no significant difference in the percentage of corn yield when mesotrione in combination with chlorpyrifos was applied compared to the application of rimsulfuron in combination with chlorpyrifos and isoxadifen (FIG. 7).

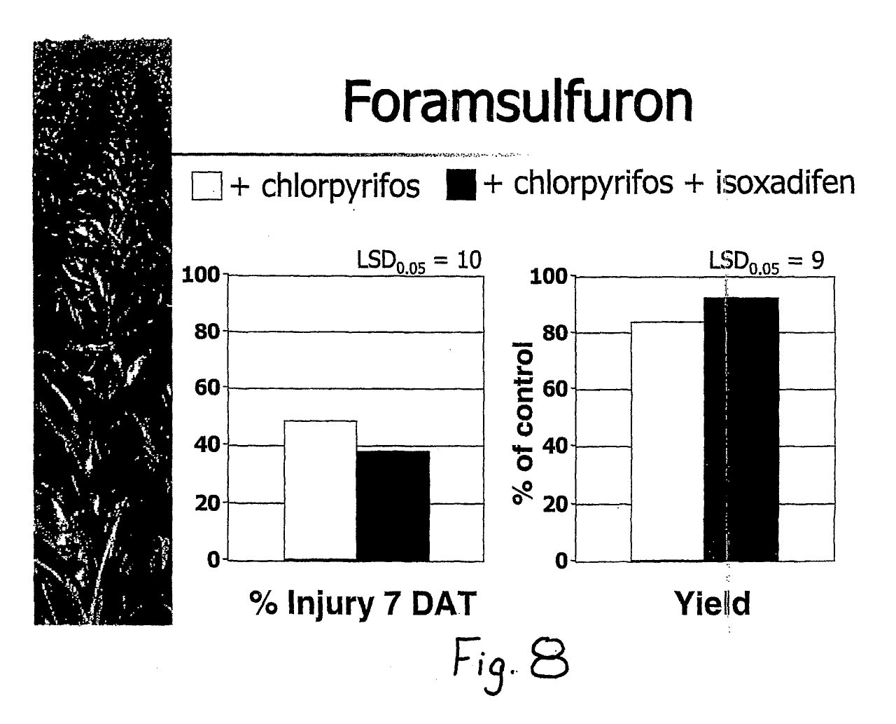

Application of the herbicide foramsulfuron in combination with chlorpyrifos caused significantly more corn injury compared to the application of the above combination and isoxadifen; and application of foramsulfuron in combination with chlorpyrifos produced a significantly smaller corn yield compared to application of the above combination and isoxadifen (FIG. 8).

TABLE 3
PERCENTAGE CORN INJURY AND CORN YIELD

| | CORN INJURY | | CORN YIELD | |
|---|---|---|---|---|
| | Chlor- | Chlor + | Chlor- | Chlor + |
| Treatment | pyrifos | Isoxadifen | pyrifos | Isoxadifen |
| Dicamba + Diflu + | 74 | 30 * | 42 | 78 * |
| Isoxadifen | | | | |
| Dicamba | 65 | 37 * | 75 | 86 * |
| Rimsulfuron | 37 | 45 | 65 | 95 * |
| Nicosulfuron + | 32 | 45 * | 68 | 94 * |
| Rimsulfuron | | | | |
| Mesotrione | 34 | 12 * | 97 | 97 |
| Foramsulfuron | 47 | 37 * | 82 | 92 * |

* P < 0.05

### Discussion

The results from this study demonstrated that the addition of isoxadifen partially protected corn from the response of mesotrione, nicosulfuron plus rimsulfuron, dicamba, dicamba plus diflufenzopyr and rimsulfuron when treatments included the organophosphate insecticide chlorpyrifos. Most post-emergence corn herbicides typically are applied in combination with an organophosphate insecticide at least 7 days before or 3 days after application of an herbicide. This study demonstrated that the use of isoxadifen reduces the level of crop injury when a treatment of an insecticide is needed at the time of the corn herbicide application. With the increase in transgenic corn hybrids with rootworm protection, the use of foliar applications of organophosphate insecticides likely will increase in order to control secondary pests. Thus, the use of the first foliar-applied corn safener, isoxadifen, likely will give more application flexibility when using these insecticides in combination with post-emergence herbicides in corn.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

The invention claimed is:

1. A method of improving yields in crops of useful plants in need of yield improvement, comprising applying a yield-improving amount of isoxadifen or an ester thereof to the plants, parts of plants, plant seeds or the area under cultivation.

2. The method according to claim 1, wherein the ethyl ester of isoxadifen is applied.

3. The method according to claim 1, wherein the useful plant is maize.

4. The method according to claim 1, wherein the yield improving amount of isoxadifen thereof to or an ester to the plant, plant part or area under cultivation ranges from about 0.001 a.i. per hectare to about 5 kg a.i. per hectare.

5. The method according to claim 1, wherein the yield improving amount of isoxadifen or an ester thereof to the plant, plant part or area under cultivation ranges from about 0.005 kg a.i. per hectare to about 0.5 kg a.i. per hectare.

6. The method according to claim 1, wherein the yield improving amount of isoxadifen or an ester thereof to the plant, plant part or area under cultivation ranges from about 0.0015 kg a.i. per hectare to about 0.1 kg a.i. per hectare.

7. The method according to claim 1, wherein the yield improving amount of isoxadifen or an ester thereof to the plant seed ranges from about 0.01 g a.i. per kg seed to about 10 g a.i. per kg seed part.

8. The method according to claim 1, wherein the yield improving amount of isoxadifen or an ester thereof to the plant seed ranges from about 0.05 g a.i. per kg seed to about 1.0 g a.i. per kg seed part.

9. The method according to claim 1, wherein the yield improving amount of isoxadifen or an ester thereof to the plant seed ranges from about 0.1 g a.i. per kg seed to about 0.5 g a.i. per kg seed part.

10. A method of improving yields in crops of useful plants in need of yield improvement, comprising applying a yield-improving amount of isoxadifen or an ester thereof and one or more herbicides and/or insecticides to the plants, parts of plants, plant seeds or the area under cultivation.

11. The method according to claim 10, wherein the useful plant is maize.

12. The method according to claim 10, wherein the herbicidally effective amount of the one or more herbicides ranges from about 0.001 kg a.i. per hectare to about 12 kg a.i. per hectare.

13. The method according to claim 10, wherein the herbicidally effective amount of the one or more herbicides ranges from about 10 g a.i. per hectare to about 3 kg a.i. per hectare.

14. The method according to claim 10, wherein the herbicidally effective amount of the one or more herbicides ranges from about 10 g a.i. per hectare to about 3 kg a.i. per hectare.

15. The method according to claim 10, wherein the herbicidally effective amount of the one or more herbicides ranges from about 20 g a.i. per hectare to about 2 kg a.i. per hectare.

16. The method according to claim 10, wherein the weight ratio of herbicide:isoxadifen is in the range from about 1:200 to 200:1.

17. The method according to claim 9, wherein the weight ratio of herbicide:isoxadifen is in the range from about 1:100 to 100:1.

18. The method according to claim 10, wherein the weight ratio of herbicide:isoxadifen is in the range from about 1:10 to 10:1.

19. The method according to claim 10, wherein the herbicides are selected from the group consisting of rimsulfuron, nicosulfuron, foramsulfuron, diflufenzopyr, mesotrione and dicamba.

20. A method of improving yields in maize in need of yield improvement, comprising applying to a maize plant, seeds of a maize plant, a locus of the maize plant and combinations thereof an effective amount of a compound selected from isoxadifen, an ester of isoxadifen and combinations thereof.

21. A method of improving yields in crops of useful plants in need of yield improvement, comprising applying a yield-improving amount of isoxadifen or an ester thereof and one or more herbicides to the plants, parts of plants, plant seeds or the area under cultivation.

22. A method of improving yields in crops of useful plants in need of yield improvement, comprising applying a yield-improving amount of isoxadifen or an ester thereof and one or more insecticides to the plants, parts of plants, plant seeds or the area under cultivation.

23. A method of improving yields in crops of useful plants in need of yield improvement, comprising applying a yield-improving amount of isoxadifen or an ester thereof and one or more insecticides and one or more herbicides to the plants, parts of plants, plant seeds or the area under cultivation.
